(19) United States
(12) Patent Application Publication
(10) Pub. No.: US 2014/0082055 A1
(43) Pub. Date: Mar. 20, 2014

(54) INCENTIVE BASED METHOD AND SYSTEM FOR COLLECTING REAL-TIME FEEDBACK

(71) Applicant: Quality Reviews, Inc., New York, NY (US)

(72) Inventor: LEONARD ACHAN, JR., BELLMORE, NY (US)

(73) Assignee: Quality Reviews, Inc., New York, NY (US)

(21) Appl. No.: 14/028,381

(22) Filed: Sep. 16, 2013

Related U.S. Application Data
(60) Provisional application No. 61/702,050, filed on Sep. 17, 2012.

(51) Int. Cl. H04L 29/08

(52) U.S. Cl. CPC H04L 67/10
USPC 709/203

(57) ABSTRACT

A system and method for collecting real-time feedback from users. A processor based server receives receiving a request to access a wireless communications network from a client device located within a host environment. Each client device is associated with a user. The server transmits a questionnaire form to the client device associated with the user over the wireless communications network. The form comprises one or more questions to solicit a real-time feedback from the user. The server receives a user's response to the form from the client device associated with the user, provides access to the wireless network to the client device associated with the user, stores the user's response to the form in a database, and inhibits access to the wireless network to the client device if the user's response to the form are determined to be incomplete or non-responsive.

### RELATED APPLICATION

This application claims the benefit of U.S. Provisional Application No. 61/702,050 filed Sep. 17, 2012, which is incorporated herein by reference in its entirety.

### FIELD OF THE INVENTION

The claimed invention relates to a system and method of collecting information or feedback from users, and more particularly to an incentive based method of collecting real-time feedbacks from users.

### BACKGROUND OF THE INVENTION

Retailers and service providers need to have a sufficient understanding of consumers' desires, experiences and requirements to ensure that the products sold or services provided are successful and well received in the market place. However, it has become increasingly impractical and increasingly difficult to have first-hand knowledge about consumer experiences and preferences, as the size of organizations and consumer populations have grown. Yet, every marketer, retailer and service provider yearns to know the motivation behind consumers' decisions to purchase certain goods and services. To fill this need, the science, art, and business of marketing research has replaced first hand experience as the link between retailer, service provider and their customers.

Random selection produces the statistical problem of establishing the population frame of interest. While surveys of the general population, represented by the typical random sample, provide useful data, the views and experiences of the segment of the population that is seriously considering the purchase of a particular product or service prove to be that much more useful. Accordingly, it would be invaluable to have the ability to map the considerations and experiences of consumers as they are utilizing a particular service or purchasing a particular product instead of querying the consumer one day, one week, or one month after such decisions have been made.

Just as retailers and service providers face the task of understanding consumer preferences, consumers face the task of obtaining sufficient information about many products and services when trying to make an informed buying decision. The task becomes most difficult when the product of interest falls into a class of services having considerable consequences, such as health care services. Each consumer attaches different importance levels to different parameters or criteria of a product/service. For example, in choosing vacation resorts or hotels, some consumers find beachfront location to be the most important factor while others find it crucial to have on-the-premises entertainment, family-friendly environment, secluded location, etc. Even after investing a considerable amount of time obtaining information from various sources, the consumer is still left wondering whether he/she has missed other possible products or services.

Further, employers face similar problems in understanding their employees' views of the company and their morale. Companies spend enormous amount of time and money in training their employees, so they have great incentive in retaining their employees and minimizing employee defections. The cost of replacing departed employees is high, especially for key employees. Accordingly, it is essential that employers have better understanding of their employees' views of the company, such as their views of company's work policy, benefits, etc., to discern bad company policies that may discourage them from staying with the company.

Accordingly, the claimed invention proceeds upon a desirability of obtaining real-time data from consumers, users and employees (collectively referred to herein as the “users”) during and immediately after purchasing or utilizing the product or services.

### SUMMARY OF THE INVENTION

Therefore, an object of the claimed invention is to provide a system and method for collecting real-time feedback user's experience with a particular product or service using a communications device.

Another object of the claimed invention is to provide the aforesaid system and method which provides an electronic form or survey to be completed by the users using their communications device while they are in the premises of the employer, retailer or service provider. In accordance with an exemplary embodiment of the claimed invention, the employer can be a small or large company, profit or non-profit company, a school or university, a hospital, a doctor's office, etc.

A still another object of the claimed invention is to provide the aforesaid method which provides incentive for the consumer to complete the electronic survey.

A yet another object of the claimed invention is to provide the aforesaid method which varies the questions on the form or survey periodically, such as daily, weekly, monthly, etc. For example, the questions can be also varied to receive feedback for a special event; an introduction of a new product, a new service or a new corporate logo; a change in store return policy, in employee benefits, in product design, in management, etc.

A still yet another object of the claimed invention is to provide the aforesaid method which provides a customized form or survey based on the their current position. In accordance with an exemplary embodiment of the claimed invention, the inventive system and method provides a location based form or survey to be completed by the users. For example, the inventive system and method provides an appliance related survey if the user is in the appliance section of the department store and provides a furniture related survey if the user is in the furniture section of the department store. The location of the user can be determined using any known global positioning system (GPS) or based on Wi-Fi access point or hotspots located throughout the department store and the like.

A further object of the claimed invention is to provide the aforesaid method which protects the identity of the user by minimizing the collection and storage of user's personal information. In accordance with an exemplary embodiment of the claimed invention, any personal information (e.g., name, address, social security number, etc.) collected from the user, if any, is depersonalized before storing the information in the database. That is, any association between the collected information and the user's identity are removed or de-associated.

In accordance with an exemplary embodiment of the claimed invention, a system for collecting real-time feedback from users comprises a wireless communications network, a plurality of client devices, a processor based server and a database for storing the user's response to the form. Each client device is associated with a user. The server is connected to the wireless communications network. The server is configured to receive a request to access the wireless communications network from a client device located within a host environment, and transmits a questionnaire form to the client device associated with the user over the wireless communications network. The form comprises one or more questions to solicit a real-time feedback from the user. The server receives a user's response to the form from the client device associated with the user over the wireless communications network, and provides access to the wireless network to the client device associated with the user.

In accordance with an exemplary embodiment of the claimed invention, the aforesaid server inhibits access to the wireless network to the client device associated with the user and transmits a request to re-complete the form if the user's response to the form are determined to be incomplete or non-responsive.

In accordance with an exemplary embodiment of the claimed invention, the aforesaid server transmits an incentive to the client device associated with the user upon receipt of a complete response to the form from the user.

In accordance with an exemplary embodiment of the claimed invention, the aforesaid server selects the form from a plurality of forms stored in the database based on a location of the client device associated with the user within the host environment.

In accordance with an exemplary embodiment of the claimed invention, the aforesaid server selects the questions of the form from a plurality of questions stored in the database.

In accordance with an exemplary embodiment of the claimed invention, the aforesaid server analyzes responses from a plurality of users and generates a report based on the responses.

In accordance with an exemplary embodiment of the claimed invention, the aforesaid server comprises a host server and a service provider's server. The host server receives the request to access from the client device and transmits the request to the service provider's server for processing. The service provider's server transmits the questionnaire form to the client device, receives the user's response to the form from the client device and provides access to the wireless network to the client device.

In accordance with an exemplary embodiment of the claimed invention, a computer based method for collecting real-time feedback from users comprises the step of receiving a request to access a wireless communications network by a processor based server from a client device located within a host environment. Each client device is associated with a user. The aforesaid method comprises the step of transmitting a questionnaire form to the client device associated with the user by the server over the wireless communications network. The form comprises one or more questions to solicit a real-time feedback from the user. The aforesaid method further comprises the steps of receiving a user's response to the form from the client device associated with the user by the server over the wireless communications network, storing the user's response in a database by the server, and providing access to the wireless network to the client device associated with the user.

In accordance with an exemplary embodiment of the claimed invention, the aforesaid method further comprises the step of inhibiting access to the wireless network to the client device associated with the user and transmitting a request to re-complete the form if the user's response to the form are determined to be incomplete or non-responsive.

In accordance with an exemplary embodiment of the claimed invention, the aforesaid method further comprises the step of transmitting an incentive to the client device associated with the user upon receipt of a complete response to the form from the user.

In accordance with an exemplary embodiment of the claimed invention, the aforesaid method further comprises the step of selecting the form from a plurality of forms stored in the database based on a location of the client device associated with the user within the host environment by the server.

In accordance with an exemplary embodiment of the claimed invention, the aforesaid method further comprises the step of selecting the questions of the form from a plurality of questions stored in the database.

In accordance with an exemplary embodiment of the claimed invention, the aforesaid method further comprises the step of analyzing the user's responses and generating a report based on the user's responses.

In accordance with an exemplary embodiment of the claimed invention, the server comprises a host server and a service provider's server, and in the aforesaid method, the host server performs the step of receiving the request to access from the client device. The service provider's server performs the steps of transmitting the questionnaire form to the client device, receiving the user's response to the form from the client device, storing the user's response in the database and providing access to the wireless network to the client device.

In accordance with an exemplary embodiment of the claimed invention, a non-transitory computer readable medium comprises computer executable code for collecting real-time feedback from users. The aforesaid code comprises instructions for receiving a request to access a wireless communications network by a processor based server from a client device located within a host environment. Each client device is associated with a user. The aforesaid code comprises instructions for transmitting a questionnaire form to the client device associated with the user by the server over the wireless communications network. The form comprises one or more questions to solicit a real-time feedback from the user. The aforesaid code further comprises instructions for receiving a user's response to the form from the client device associated with the user by the server over the wireless communications network, storing the user's response in a database by the server, and providing access to the wireless network to the client device associated with the user.

In accordance with an exemplary embodiment of the claimed invention, the aforesaid code further comprises instructions for inhibiting access to the wireless network to the client device associated with the user and transmitting a request to re-complete the form if the user's response to the form are determined to be incomplete or non-responsive.

In accordance with an exemplary embodiment of the claimed invention, the aforesaid code further comprises instructions for transmitting an incentive to the client device associated with the user upon receipt of a complete response to the form from the user.

In accordance with an exemplary embodiment of the claimed invention, the aforesaid code further comprises instructions for selecting the form from a plurality of forms stored in the database based on a location of the client device associated with the user within the host environment by the server.

In accordance with an exemplary embodiment of the claimed invention, the aforesaid code further comprises instructions for selecting the questions of the form from a plurality of questions stored in the database.

In accordance with an exemplary embodiment of the claimed invention, the aforesaid code further comprises instructions for analyzing the user's responses and generating a report based on the user's responses.

Various other objects, advantages, and features of the claimed invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings in which:

FIG. 1 is a block diagram of the system in accordance with an exemplary embodiment of the claimed invention;

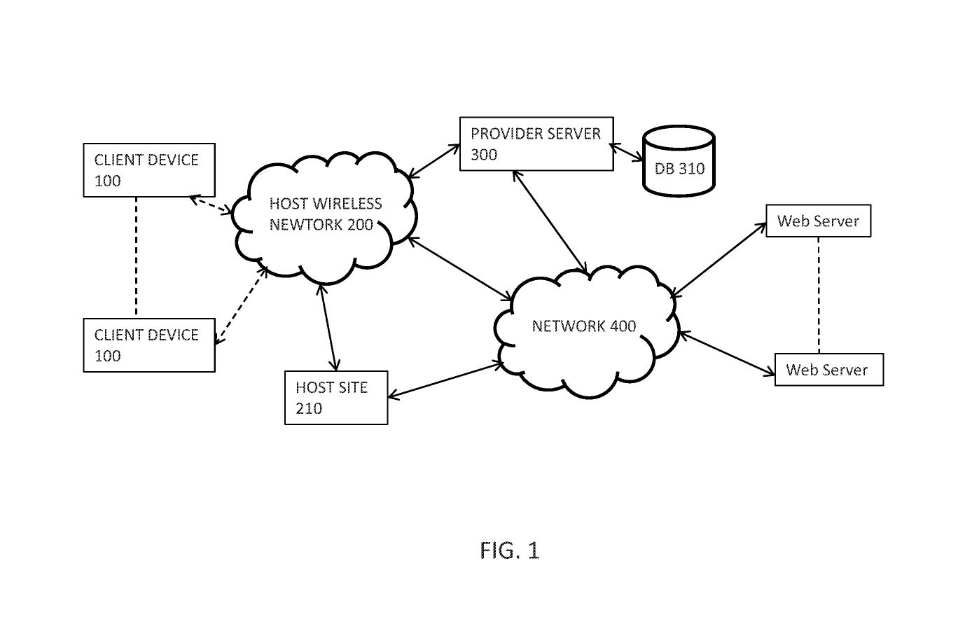

FIG. 2 is a block diagram of the system architecture in accordance with an exemplary embodiment of the claimed invention; and

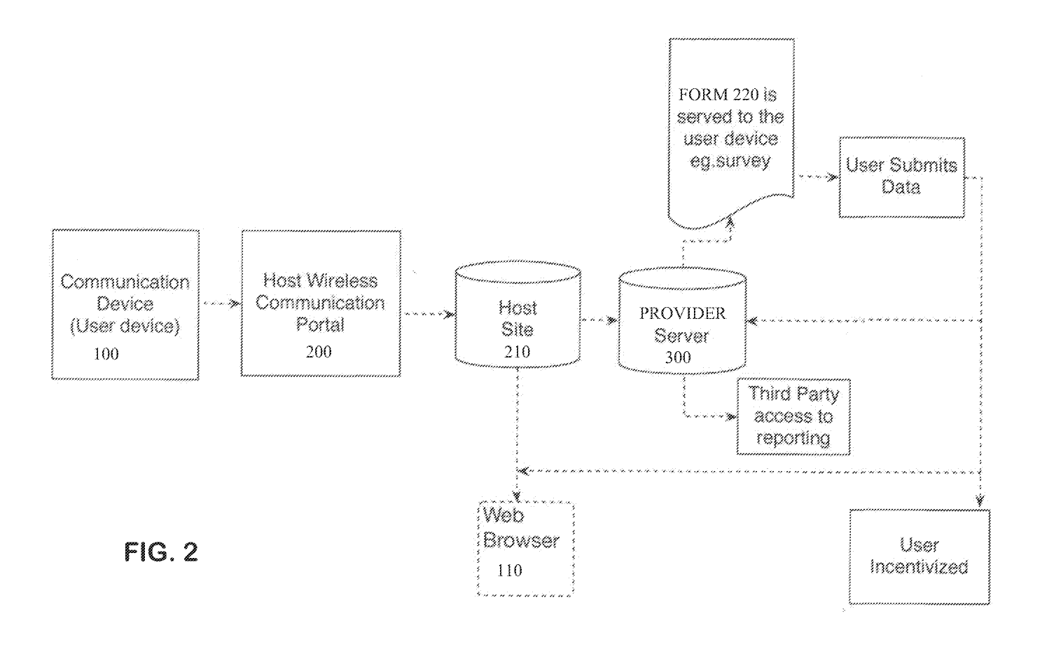

FIG. 3 is a block diagram of the system architecture in accordance with an exemplary embodiment of the claimed invention.

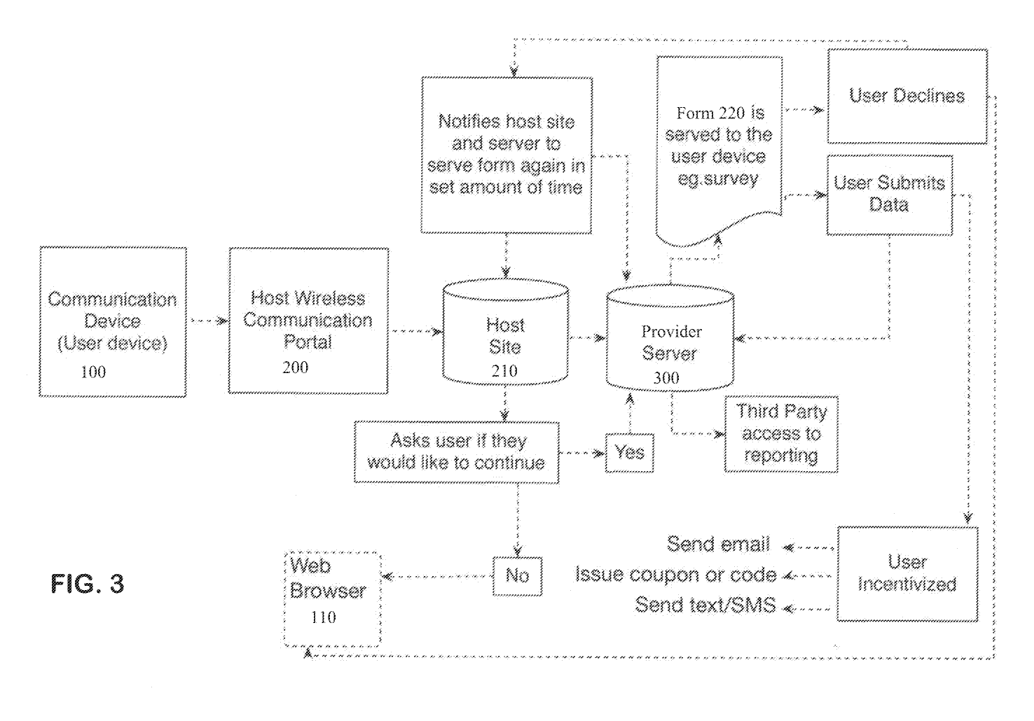

### DETAILED DESCRIPTION OF THE EMBODIMENTS

The term “communications device” or “user device” represents an information processor or device, such as personal digital assistant, web-enabled device, tablet, laptop, net book, mobile or smart phone, wireless device and other comparable portable devices. Among other things, the communications device can interface with a communications network, such as the Internet, to accept a user's input by any means possible. Such means include, but are not limited to, (1) touch, such as a keyboard, touch sensitive surface, pointing device, and the like; (2) sound, such as voice, handclap, or any other sound; (3) light, in both the visible or not visible spectrum; and (4) any other input means. A “communications device” can also notify a user of received information and display such information by any means, including but not limited to visual, audio, and mechanical motion means.

The claimed invention is readily implemented by presently available communications apparatus and electronic components. The invention find ready application in virtually all commercial communications networks, including, but not limited to an intranet, a local area network (LAN), a wide area network (WAN), world wide web, a telephone network, a wireless network, and a wired cable transmission system. The communications device can access these communications network using Bluetooth® (a registered trademark of Bluetooth SIG, Inc.), Wi-Fi® (a registered trademark of Wi-Fi Alliance Corporation) and any other comparable means.

In accordance with an embodiment of the claimed invention, the computer-based methods for implementing the claimed invention are implemented using processor-executable instructions for directing operation of a device or devices under processor control, the processor-executable instructions can be stored on a tangible, non-transitory computer-readable medium, such as but not limited to a disk, CD, DVD, flash memory, portable storage or the like. The processor-executable instructions can be accessed from a service provider's website or stored as a set of downloadable processor-executable instructions, for example or downloading and installation from an Internet location, e.g. the server 300 or another web server (not shown).

In accordance with an exemplary embodiment of the claimed invention, the service provider, employer or retailer, such as a coffee retailer, a hospital, a health care provider, a hotel, a restaurant, an automobile dealer, etc., can provide incentives in the form of free Wi-Fi access to the Internet 400, a coupon for a free coffee, a coupon for a free meal, a coupon for $20 off on their next meal, etc., to encourage their users/consumers to complete a survey using their communications devices.

In accordance with an exemplary embodiment of the claimed invention, the claimed invention will be described where the retailer/service provider provides a free Wi-Fi access as an incentive for completing a survey in real-time. The claimed invention utilizes the user's communications device 100 (or user device 100) for real time data gathering when the customer enters an environment with wireless communication portals (host) 200, such as Wi-Fi, Bluetooth, etc.

When accessing a host's wireless communication portal 200, the user device 100 will be prompted by the host site 210 (host webpage) managed by a host's processor based server whereby a passive system (automatic redirect of that webpage) or an active system (accepting participation in a survey by clicking a button for example) will redirect the user device's web browser from the host site 210 to a provider's processor based server 300 which will immediately serve a form 220 (e.g., a survey) to that user device 100 and be displayed for the user in the appearance of a device specific optimized web page. In accordance with an exemplary embodiment of the claimed invention, the server 300 selects a form from a plurality of forms stored in a database 310 or selects questions from a plurality of questions stored in the database 310 to generate the form.

Once the user device 100 is initially redirected to the form/survey 220, it can afterwards be accessed via cellular network connections in the event of any downtime of the host's Wi-Fi network 200, for example. Furthermore, downtime of a wireless portal 200 in the host environment would be resolved by data being backed up by caching of the page within the user device 100 until either the wireless or cellular signal is reconnected. Unique identification methods (e.g., IP address) will also be used to associate a user devices owner (user) to the data submitted to the provider's server 300. This will also provide a safety mechanism to ensure data validity by preventing the user from submitting more than one survey within any specified period of time, which can be determined by the host.

This survey 220 would then allow for real time data collection from the user while they remain within the host environment. Data such as ratings, feedback, demographic information, contact information, market research, etc. can be gathered at that time on the provider's server 300. On completion and submission of the gathered data, the user will at that time gain access to the destination homepage determined by the host. The user will at that time receive some incentive via email or on the submission confirmation page (e.g., free Wi-Fi, coupon, free item, entering a sweepstakes, etc.) The user can then normally continue web browsing using the host's wireless communication portal 200.

On the spot, real time data gathering is enabled through the claimed system and method by ensuring that the form being served was a direct result of the user visiting the host environment and attempting to access their wireless network 200. Increased participation and submissions are also achieved in comparison to paper based forms used in traditional data collection methods which are often delayed, preventing real time data collection, management and follow up. Once the data is collected and submitted, the user will receive access to the wireless network 200 and/or be incentivized for their participation. The data gathered can be simultaneously analyzed on the provider's server 300 and reports can be created on a secure password protected portal. This portal will contain a dashboard presenting the data in a customized format for viewing by third parties (e.g., host). The data can be used for the real time reporting and management of the host for the first time by having immediate access to the data provided by users. This accounts for the validity of data gathered by ensuring that the user is in the right place at the time on a localized host wireless network 200.

In accordance with an exemplary embodiment of the claimed invention, the provider's server 300 provides a customized form/survey 220 based on the user's current position or location. That is, the provider's server 300 provides location based form or survey to be completed by the users. For example, if the host environment is a department store, then the server 300 provides an appliance related survey 220 if the user is in the appliance section of the department store and provides a furniture related survey 220 if the user is in the furniture section of the department store. For example, if the host environment is a hospital, then the server 300 provides a survey 220 relating to the quality of food, service and the like if the user is in the hospital cafeteria and provides a survey 220 relating to the admission process, wait time and the like if the user is waiting to be admitted to the hospital. The location of the user can be determined using any known global positioning system (GPS) or based on Wi-Fi access point or hotspots located throughout the department store and the like.

In accordance with an exemplary embodiment of the claimed invention, a computer based method for collecting real-time feedback from users comprises the step of receiving a request to access a wireless communications network by a processor based server from a client device located within a host environment. Each client device is associated with a user. The aforesaid method comprises the step of transmitting a questionnaire form to the client device associated with the user by the server over the wireless communications network. The form comprises one or more questions to solicit a real-time feedback from the user. The aforesaid method further comprises the steps of receiving a user's response to the form from the client device associated with the user by the server over the wireless communications network, storing the user's response in a database by the server, and providing access to the wireless network to the client device associated with the user.

In accordance with an exemplary embodiment of the claimed invention, a non-transitory computer readable medium comprises computer executable code for collecting real-time feedback from users. The aforesaid code comprises instructions for receiving a request to access a wireless communications network by a processor based server from a client device located within a host environment. Each client device is associated with a user. The aforesaid code comprises instructions for transmitting a questionnaire form to the client device associated with the user by the server over the wireless communications network. The form comprises one or more questions to solicit a real-time feedback from the user. The aforesaid code further comprises instructions for receiving a user's response to the form from the client device associated with the user by the server over the wireless communications network, storing the user's response in a database by the server, and providing access to the wireless network to the client device associated with the user.

Case Scenario:

A user entering an establishment, e.g., hotel, movie theater, café can access wireless networks 200, e.g., Bluetooth or Wi-Fi, for free or in most circumstances for a fee or as a patron (user) of that establishment. This wireless access provides an excellent medium for the user and establishment to engage one another (in the exact moment of an experience) to collect data such as real time ratings, market research or feedback and provide that data for real time observation and management of that environment.

Example A: A user walks into a well-known coffee shop or restaurant and accesses the Wi-Fi 200 or is pushed a prompt via Bluetooth, the user's device 100 is delivered a webpage which immediately redirects the user's device 100 to provider's form 220 which allows seamless data gathering on the provider's server 300 and instant reporting of user's feedback or ratings to coffee shop/restaurant's onsite management team on a password protected dashboard. This can tell them how the user/consumer rated her experience (e.g., customer service such as cleanliness, friendliness, pricing, quality, etc.) Upon completion of the survey 220, the user can be incentivized (e.g., receiving a discount coupon via email, a cup of coffee or simply gaining free access to Wi-Fi for a predetermined period of time). On completion of the data gathering, the user is immediately redirected to the coffee shop or restaurant's destination page or user's browser 110 for continued Internet access.

Example B: A user enters a movie theater and a prompt on the user's mobile device 100 redirects the user to the provider's form 220 as a survey allowing the user to provide feedback about the user/customer experience. Alternatively, the user's mobile device 100 receives the provider's form 220 to rate the movie itself instantly providing real time ratings on a survey 220 after the movie (guaranteeing that the survey is completed by an actual viewer/customer of the movie, preferably, shortly after viewing the movie, and increasing the likelihood of user participation in the survey). The claimed invention offers an incentive (e.g., coupons, free popcorn or entering to win a sweepstakes).

Example C: A customer leaves the counter at a well-known department store or electronic chain after a purchase and instead of asking the customer to rate her experience when the customer gets home by signing into an online portal listed at the bottom of the receipt in exchange for a coupon, the customer receives an instant text message on the customer's mobile device 100 with a link bringing the customer to a webpage with the provider's form 220 which asks the customer to rate her experience with the salesperson that assist her in the store or rate the store itself. The claimed invention advantageously provides instant feedback of how the customer felt at that exact moment instead of recalling their experiences several hours or days later. The claimed invention advantageously permits the claimed system and method to capture the user's actual experience as it unfolds.

Example D: A patient in a hospital, signing onto Wi-Fi 200 and being redirected to the provider's form/survey 220 asking the patient rate her patient experience in different categories from 1-5 stars. This allows the patient to rate her actual feelings at that moment and not on a piece of paper mailed to patient's home a few months after she is discharged. Immediately after her submission, the patient receives free Wi-Fi, free cable TV or free telephone service for a predetermined period or the like. If the patient agrees to take a longer or more extensive survey 220, the patient receives a coupon for free TV service during her admission. The hospital administration can now see for the first time ever how patients and visitors actually feel about the hospital at that very moment of the day and can manage resources to more efficiently address their concerns.

Various omissions, modifications, substitutions and changes in the forms and details of the device illustrated and in its operation can be made by those skilled in the art without departing in any way from the spirit of the present invention. Accordingly, the scope of the invention is not limited to the foregoing specification, but instead is given by the appended claims along with their full range of equivalents.

1. A system for collecting real-time feedback from users, comprising:
a wireless communications network;
a plurality of client devices, each client device is associated with a user;
a processor based server connected to the wireless communications network, and configured to receive a request to access the wireless communications network from a client device located within a host environment, transmit a questionnaire form to the client device associated with the user over the wireless communications network, the form comprising one or more questions to solicit a real-time feedback from the user, receive a user's response to the form from the client device associated with the user over the wireless communications network, and provide access to the wireless network to the client device associated with the user; and
a database for storing the user's response to the form.

2. The system of claim 1, wherein the server inhibits access to the wireless network to the client device associated with the user and transmits a request to re-complete the form if the user's response to the form are determined to be incomplete or non-responsive.

3. The system of claim 1, wherein the server transmits an incentive to the client device associated with the user upon receipt of a complete response to the form from the user.

4. The system of claim 1, wherein the server selects the form from a plurality of forms stored in the database based on a location of the client device associated with the user within the host environment.

5. The system of claim 1, wherein the server selects the questions of the form from a plurality of questions stored in the database.

6. The system of claim 1, wherein the server analyzes responses from a plurality of users and generates a report based on the responses.

7. The system of claim 1, wherein the server comprises a host server and a service provider's server; and wherein the host server receives the request to access from the client device and transmits the request to the service provider's server for processing; and wherein the service provider's server transmits the questionnaire form to the client device, receives the user's response to the form from the client device and provides access to the wireless network to the client device.

8. A computer based method for collecting real-time feedback from users, comprising the steps of:
receiving a request to access a wireless communications network by a processor based server from a client device located within a host environment, each client device is associated with a user;
transmitting a questionnaire form to the client device associated with the user by the server over the wireless communications network, the form comprising one or more questions to solicit a real-time feedback from the user;
receiving a user's response to the form from the client device associated with the user by the server over the wireless communications network;
storing the user's response in a database by the server; and
providing access to the wireless network to the client device associated with the user.

9. The method of claim 8, further comprising the step of inhibiting access to the wireless network to the client device associated with the user and transmitting a request to re-complete the form if the user's response to the form are determined to be incomplete or non-responsive.

10. The method of claim 8, further comprising the step of transmitting an incentive to the client device associated with the user upon receipt of a complete response to the form from the user.

11. The method of claim 8, further comprising the step of selecting the form from a plurality of forms stored in the database based on a location of the client device associated with the user within the host environment by the server.

12. The method of claim 8, further comprising the step of selecting the questions of the form from a plurality of questions stored in the database.

13. The method of claim 8, further comprising the step of analyzing the user's responses and generating a report based on the user's responses.

14. The method of claim 8, wherein the server comprises a host server and a service provider's server; and wherein the host server performs the step of receiving the request to access from the client device; and wherein the service provider's server performs the steps of transmitting the questionnaire form to the client device, receiving the user's response to the form from the client device, storing the user's response in the database and providing access to the wireless network to the client device.

15. A non-transitory computer readable medium comprising computer executable code for collecting real-time feedback from users, the code comprising instructions for:
receiving a request to access a wireless communications network by a processor based server from a client device located within a host environment, each client device is associated with a user;
transmitting a questionnaire form to the client device associated with the user by the server over the wireless communications network, the form comprising one or more questions to solicit a real-time feedback from the user;
receiving a user's response to the form from the client device associated with the user by the server over the wireless communications network;
storing the user's response in a database by the server; and
providing access to the wireless network to the client device associated with the user.

16. The computer readable medium of claim 15, wherein the code further comprises instructions for inhibiting access to the wireless network to the client device associated with the user and transmitting a request to re-complete the form if the user's response to the form are determined to be incomplete or non-responsive.

17. The computer readable medium of claim 15, wherein the code further comprises instructions for transmitting an incentive to the client device associated with the user upon receipt of a complete response to the form from the user.

18. The computer readable medium of claim 15, wherein the code further comprises instructions for selecting the form from a plurality of forms stored in the database based on a location of the client device associated with the user within the host environment by the server.

19. The computer readable medium of claim 15, wherein the code further comprises instructions for selecting the questions of the form from a plurality of questions stored in the database.

20. The computer readable medium of claim 15, wherein the code further comprises instructions for analyzing the user's responses and generating a report based on the user's responses.
